(19) United States
(12) Patent Application Publication
(10) Pub. No.: US 2025/0284983 A1
(43) Pub. Date: Sep. 11, 2025

(54) SYSTEM AND METHOD FOR UAI HARDWARE BASED FILTERING

(71) Applicant: Aeronix, Inc., Melbourne, FL (US)

(72) Inventors: Levi Mutter, Melbourne, FL (US); Patrick Hagerty, Melbourne, FL (US); Ted Dubroff, Melbourne, FL (US)

(73) Assignee: Aeronix, Inc., Melbourne, FL (US)

(21) Appl. No.: 19/073,733

(22) Filed: Mar. 7, 2025

Related U.S. Application Data
(60) Provisional application No. 63/562,489, filed on Mar. 7, 2024.

(51) Int. Cl. G06N 5/025

(52) U.S. Cl. CPC G06N 5/025

(57) ABSTRACT

A system for filtering messages sent to a processing engine from a data stream including: (1) a detection block adapted to parse a plurality of messages received from the data stream; (2) a memory adapted to store the plurality of parsed messages; (3) a comparator adapted to compare a most recently parsed message to each of the plurality of parsed messages stored in the memory; and (4) a rules engine adapted to transmit the most recently parsed message to the processing engine if a threshold condition is met.

### RELATED APPLICATIONS

This application claims priority under 35 U.S.C. § 119(e) of U.S. Provisional Patent Application Ser. No. 63/562,489 (Attorney Docket No. 1949.00018) filed on Mar. 7, 2024 and titled SYSTEM AND METHOD FOR UAI HARDWARE BASED FILTERING. The content of this application is incorporated herein by reference.

### FIELD OF THE INVENTION

The present invention relates to systems and methods for utilizing hardware to detect duplicate messages in a data stream and prevent them from being provided to a processing engine to improve software efficiency. More specifically, the present invention may prevent duplicate messages in a Universal Armament Interface (UAI) data stream from being provided to a processing engine implemented in software.

### BACKGROUND OF THE INVENTION

Messages used in a Universal Armament Interface (UAI) data stream are often repetitive in their content and there may be a high rate of data transmission. This places a large burden on the processing engine analyzing the messages. In practice, systems implementing a UAI often contain large amounts of messages and most of these messages are unnecessary for systems that are analyzing traffic data to receive. Therefore a need exists for a system that may filtered out unnecessary messages before software adapted to analyze traffic data receives them.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a system for filtering messages sent to a processing engine from a data stream, which may include a detection block, a memory, a comparator, and a rules engine. The detection block may be adapted to parse a plurality of messages received from the data stream. The memory may be adapted to store the plurality of parsed messages. The comparator may be adapted to compare a most recently parsed message to each of the plurality of parsed messages stored in the memory. The rules engine may be adapted to transmit the most recently parsed message to the processing engine if a threshold condition is met.

The most recently parsed message may not be sent to the processing engine if the threshold condition is not met.

Each of the plurality of messages may comprise a message type having a message type value and at least one data word having a data word value.

In one embodiment, the threshold condition may be met when the most recent message type value and each of the at least one data word values of the recently parsed message are not equal to the message type value and each of the at least one data word values of any of the plurality of parsed messages stored in the memory.

The memory may be adapted to store only the most recently received message of each message type value.

In one embodiment, the threshold condition may be met when at least one data word value of the most recently received message is not equal to any corresponding data word value of the parsed message stored in the memory having an equal message type value.

A count may be incremented for each message that is received and does not meet the threshold condition.

The count may be provided to the processing engine.

In one embodiment, the threshold condition may be met when the message type of the most recently parsed message is equal to a target message type.

The target message type may be selectable by a user of the system.

In one embodiment, the threshold condition may be met when (1) the message type of the most recently parsed message is equal to a target message type and (2) at least one data word value of the most recently received message is not equal to any corresponding data word value of the parsed message stored in the memory having an equal message type value.

### BRIEF DESCRIPTION OF THE DRAWINGS

Some embodiments of the present invention are illustrated as an example and are not limited by the figures of the accompanying drawings, in which like references may indicate similar elements.

FIG. 1 is a block diagram of the system for filtering messages according to one embodiment of the invention.

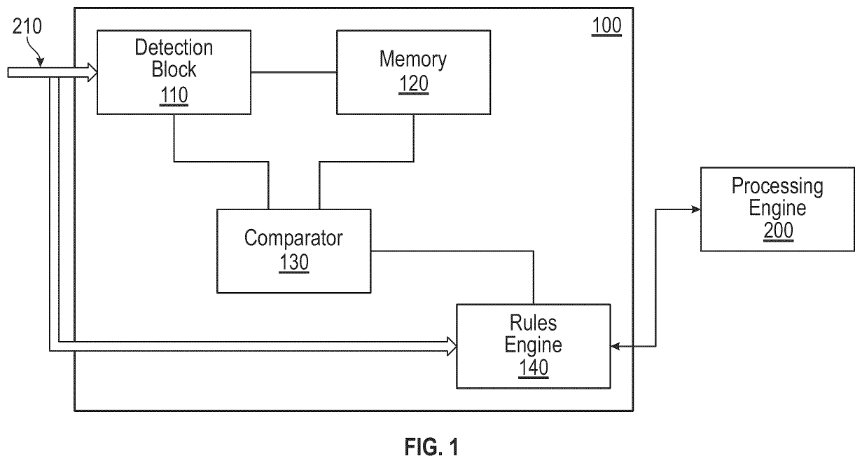

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides system for filtering messages 100 sent to a processing engine 200 from a data stream 210. In one embodiment, the system 100 may be a hardware component to filter unwanted messages out of a data stream 210, which by way of example, and not as a limitation, may be a Universal Armament Interface (UAI) data stream. This may result in fewer messages provided to the processing engine 200 and may allow the system to operate more efficiently by reducing the processing required by the engine. In one embodiment, the processing engine 200 may be software.

Messages used in a UAI data stream are often repetitive in their content and there may be a high rate of data transmission. The system for filtering messages 100 may be utilized to remove unwanted messages prior to providing these messages to a processing engine 200, thereby relieving the burden placed on the processing engine 200. In practice, systems implementing a UAI often contain large amounts of messages and most of these messages are unnecessary for systems that are analyzing traffic data to receive. These unnecessary messages may be filtered out by the system 100 before a processing engine, which, by way of example and not as a limitation, may be software adapted to analyze traffic data, receives them. These duplicate messages may be filtered in multiple ways.

In one embodiment, referred to herein as an A-Type filter, a filter may discard repeated identical messages while keeping track of the count of that repeated message. In such an embodiment, rather than providing a message to the software multiple times, the message would be provided to the software only once, along with information to identify how many times the message has been received.

In another embodiment, referred to herein as a B-Type Filter, a filter may be applied based on content contained in the message itself.

The following tables are presented to illustrate exemplary embodiments of both an A-Type and a B-Type filter.

Table 1 provides details of twelve messages received on the UAI and provided to the hardware filter.

TABLE 1

| | Message | Data Word 1 | Data Word 2 | Data Word 3 |
|---|---|---|---|---|
| Message time | Type | (hex) | (hex) | (hex) |
| 000:001 | A | 0123 | 0000 | AAAA |
| 000:002 | B | 0400 | 0000 | BBBB |
| 000:003 | C | 0510 | 0000 | CCCC |
| 000:004 | A | 0123 | 0000 | AAAA |
| 000:005 | B | 0400 | 0000 | BBBB |
| 000:006 | C | 0510 | 0000 | CCCC |
| 000:007 | B | 0400 | 0010 | BBBB |
| 000:008 | D | 5432 | 7654 | DDDD |
| 000:009 | A | 0123 | 0000 | AAAA |
| 000:010 | C | 0510 | 0000 | CCCC |
| 000:011 | A | 0123 | 0000 | AAAA |
| 000:012 | B | 0400 | 0000 | BBBB |

An A-Type Filter could be applied to the messages shown in Table 1. This filter would discard any messages of the same type with repeated content, which would result in providing only the six messages of Table 2 to the software for processing. Implementation of this A-Type Filter only allows messages of a given type to pass through the filter if the data contained in that message is different from the data contained in the last message of the same type.

TABLE 2

| | Message | Data Word 1 | Data Word 2 | Data Word 3 |
|---|---|---|---|---|
| Message time | Type | (hex) | (hex) | (hex) |
| 000:001 | A | 0123 | 0000 | AAAA |
| 000:002 | B | 0400 | 0000 | BBBB |
| 000:003 | C | 0510 | 0000 | CCCC |
| 000:007 | B | 0400 | 0010 | BBBB |
| 000:008 | D | 5432 | 7654 | DDDD |
| 000:012 | B | 0400 | 0000 | BBBB |

In an embodiment, a B-Type Filter could be applied to the messages shown in Table 1. The filter may be configurable to specify what content must be contained in the message to allow it to pass through the filter. As depicted in Table 3, a user could configure the filter to discard every message that is not of the type “B”. Such an embodiment would allow only the messages shown in Table 3 to be provided to the software for further processing.

TABLE 3

| | Message | Data Word 1 | Data Word 2 | Data Word 3 |
|---|---|---|---|---|
| Message time | Type | (hex) | (hex) | (hex) |
| 000:002 | B | 0400 | 0000 | BBBB |
| 000:005 | B | 0400 | 0000 | BBBB |
| 000:007 | B | 0400 | 0010 | BBBB |
| 000:012 | B | 0400 | 0000 | BBBB |

In some embodiments, both A-Type and B-Type filters may be used. By way of example, and not as a limitation, the A-Type filter illustrated by Table 2 may be used in combination with the B-Type filter illustrated by Table 3. The combination of applying both filters would result in allowing only the messages depicted in Table 4 through the filter, which are B types messages when they change values.

TABLE 4

| | Message | Data Word 1 | Data Word 2 | Data Word 3 |
|---|---|---|---|---|
| Message time | Type | (hex) | (hex) | (hex) |
| 000:002 | B | 0400 | 0000 | BBBB |
| 000:007 | B | 0400 | 0010 | BBBB |
| 000:012 | B | 0400 | 0000 | BBBB |

In one embodiment, a detection block 110 may receive the data stream 210 and parse a plurality of messages carried therein. By way of example, and not as a limitation, the detection block 110 may implemented by a processor, ASIC, FPGA, or the like. Parsed messages may be stored in memory 120. A comparator 130 may be used to compare a most recently parsed message to one or more previously parsed messages stored in memory 120. By way of example, and not as a limitation, the comparator 130 may implemented by a processor, ASIC, FPGA, or the like. The comparator 130 may send the results of the comparison to a rules engine 140. The rules engine 140 may provide the message to the processing engine 200 only if the results received from the comparator 130 meet a threshold condition. The message may not be provided to the processing engine 200 if the threshold condition is not met. By way of example, and not as a limitation, the rules engine 140 may implemented by a processor, ASIC, FPGA, or the like.

One skilled in the art will appreciate that one or more of the detection block 110, memory 120, comparator 130, and rules engine 140 may be implemented by a single hardware component.

The comparator 130 may implement the A-Type or B-Type filters described above, or may implement a combination of both the A-Type and B-Type filters.

In one embodiment, the memory 120 may store only the most recently received message of any message type. This may prevent the memory 120 from saving duplicate copies of identical messages and may increase efficiency as the most recently received message must only be compared to the second most recently received message of any data type, rather than to all previously received messages.

The comparator 130, rules engine 140, or combination of both may keep a count of how many identical messages have been received and provide that information to the processing engine 200.

In one embodiment, the specific message type that may meet the threshold condition and be provided to the processing engine 200 may be provided by a user of the system. In such an embodiment, this information may be provided to the rules engine 140 by the processing engine 200.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

Thus, the scope of the invention should be determined by the appended claims and their legal equivalents, and not by the examples given.

What is claimed is:

1. A system for filtering messages sent to a processing engine from a data stream comprising:
a detection block adapted to parse a plurality of messages received from the data stream;
a memory adapted to store the plurality of parsed messages;
a comparator adapted to compare a most recently parsed message to each of the plurality of parsed messages stored in the memory; and
a rules engine adapted to transmit the most recently parsed message to the processing engine if a threshold condition is met.

2. The system of claim 1 wherein the most recently parsed message is not sent to the processing engine if the threshold condition is not met.

3. The system of claim 1 wherein each of the plurality of messages comprises a message type having a message type value and at least one data word having a data word value.

4. The system of claim 3 wherein the threshold condition is met when the most recent message type value and each of the at least one data word values of the recently parsed message are not equal to the message type value and each of the at least one data word values of any of the plurality of parsed messages stored in the memory.

5. The system of claim 3 wherein the memory is adapted to store only the most recently received message of each message type value.

6. The system of claim 5 wherein the threshold condition is met when at least one data word value of the most recently received message is not equal to any corresponding data word value of the parsed message stored in the memory having an equal message type value.

7. The system of claim 6 wherein a count is incremented for each message that is received and does not meet the threshold condition.

8. The system of claim 7 wherein the count is provided to the processing engine.

9. The system of claim 3 wherein the threshold condition is met when the message type of the most recently parsed message is equal to a target message type.

10. The system of claim 9 wherein the target message type is selectable by a user of the system.

11. The system of claim 5 wherein the memory is adapted to store only the most recently received message of each message type value, and the threshold condition is met when (1) the message type of the most recently parsed message is equal to a target message type and (2) at least one data word value of the most recently received message is not equal to any corresponding data word value of the parsed message stored in the memory having an equal message type value.

12. The system of claim 11 wherein the target message type is selectable by a user of the system.

13. The system of claim 10 wherein a count is incremented for each message that is received and does not meet the threshold condition.

14. The system of claim 13 wherein the count is provided to the processing engine.

15. A system for filtering messages sent to a processing engine from a data stream comprising:
a detection block adapted to parse a plurality of messages received from the data stream wherein each of the plurality of messages comprises a message type having a message type value and at least one data word having a data word value;
a memory adapted to store only the most recently received message of each message type value;
a comparator adapted to compare a most recently parsed message to each of the plurality of parsed messages stored in the memory; and
a rules engine adapted (1) to transmit the most recently parsed message to the processing engine if a threshold condition is met and (2) to not transmit the processing engine if the threshold condition is not met; and
wherein the threshold condition is met when at least one data word value of the most recently received message is not equal to any corresponding data word value of the parsed message stored in the memory having an equal message type value.

16. The system of claim 15 wherein a count is incremented for each message that is received and does not meet the threshold condition.

17. A system for filtering messages sent to a processing engine from a data stream comprising:
a detection block adapted to parse a plurality of messages received from the data stream wherein each of the plurality of messages comprises a message type having a message type value and at least one data word having a data word value;
a memory adapted to store the plurality of parsed messages;
a comparator adapted to compare a most recently parsed message to each of the plurality of parsed messages stored in the memory; and
a rules engine adapted to transmit the most recently parsed message to the processing engine if a threshold condition is met; and
wherein the threshold condition is met when the message type of the most recently parsed message is equal to a target message type.

18. The system of claim 17 wherein a count is incremented for each message that is received and does not meet the threshold condition.

19. The system of claim 17 wherein the memory is adapted to store only the most recently received message of each message type value; and
wherein the threshold condition is met when at least one data word value of the most recently received message is not equal to any corresponding data word value of the parsed message stored in the memory having an equal message type value.

20. The system of claim 19 wherein a count is incremented for each message that is received and does not meet the threshold condition.
